(19) United States
(12) Patent Application Publication
(10) Pub. No.: US 2020/0160235 A1
(43) Pub. Date: May 21, 2020

(54) METHOD AND SYSTEM OF SCHEDULING RIDES IN A RIDE-SHARING PLATFORM

(71) Applicant: William Willner, Manor, TX (US)

(72) Inventor: William Willner, Manor, TX (US)

(21) Appl. No.: 16/688,760

(22) Filed: Nov. 19, 2019

Related U.S. Application Data
(60) Provisional application No. 62/770,089, filed on Nov. 20, 2018.

(51) Int. Cl. G06Q 10/02; G08G 1/00; G06Q 30/06

(52) U.S. Cl. CPC G06Q 10/02; G06Q 30/0619; G06Q 30/0611; G08G 1/202

(57) ABSTRACT

A method for providing a ride-sharing platform may include sending driver trip information from a plurality of driver devices and rider trip information from a plurality of rider devices to a communication module on a platform server, receiving by a ride matching module on the server the rider destination information and rider starting location, receiving the driver destination information, sending to a matched driver device the rider trip information comprising the rider destination information and rider starting information for a matched rider device, displaying on the matched driver device the matched rider destination information and rider starting information, waiting for reservation input, and confirming the reservation input.

### CROSS-REFERENCE TO RELATED APPLICATIONS

This application is related and claims priority to U.S. Provisional Application No. 62/770,089 filed Nov. 20, 2018 entitled “METHOD AND SYSTEM OF SCHEDULING RIDES IN A RIDE-SHARING PLATFORM”, which is incorporated by reference in entirety.

### FIELD OF THE DISCLOSURE

The disclosure is generally directed at systems and methods for ride-sharing and, more specifically, at a method and system of scheduling rides in a ride-sharing platform.

### BACKGROUND

Need exists to improve the efficiency, cost and utilization of unused ride-sharing capacity, to benefit riders and drivers. Need exists to improve communication of available ride-sharing opportunities in real time. Need exists to facilitate opportunities for negotiation of ride-sharing transactions between riders and drivers in an efficient, automated manner in real-time. Need exists to provide updated information to drivers and riders, when such information changes in real-time, and thus to facilitate improved decision-making by riders and drivers.

### SUMMARY OF THE DISCLOSURE

The disclosure is directed at a method and system of scheduling rides in a ride-sharing platform. In one embodiment, the system provides the functionality for both riders and drivers to connect with each other when a need arises for either a rider or riders or a driver. The rider may post their trip requirements on the platform whereby a driver may then connect with the rider to provide the necessary service to complete the trip requirement. Alternatively, a driver may post their travel itinerary on the platform and a rider may then connect with the driver to take advantage of the driver's travel itinerary.

### BRIEF DESCRIPTION OF THE DRAWINGS

Embodiments of the present disclosure will now be described, by way of example only, with reference to the attached Figures.

FIG. 1 is a schematic diagram of a system for scheduling rides in a ride-sharing platform;

FIG. 2 is a schematic diagram of a server for use in the system of FIG. 1; and

FIGS. 3a, 3b and 3c are flowcharts depicting a method for scheduling riders in a ride-sharing platform.

### DETAILED DESCRIPTION

The disclosure is directed at a method and system of scheduling rides in a ride-sharing platform. The system and method includes the functionality of connection riders and drivers together so that riders can reserve a ride to get to a predetermined destination and also includes the functionality to connect drivers with riders so that drivers can take riders to a predetermined destination (which is reasonably close to the driver's original destination or a long the way back to the driver's original destination) instead of having to drive back to the original destination without a fare (or an empty run).

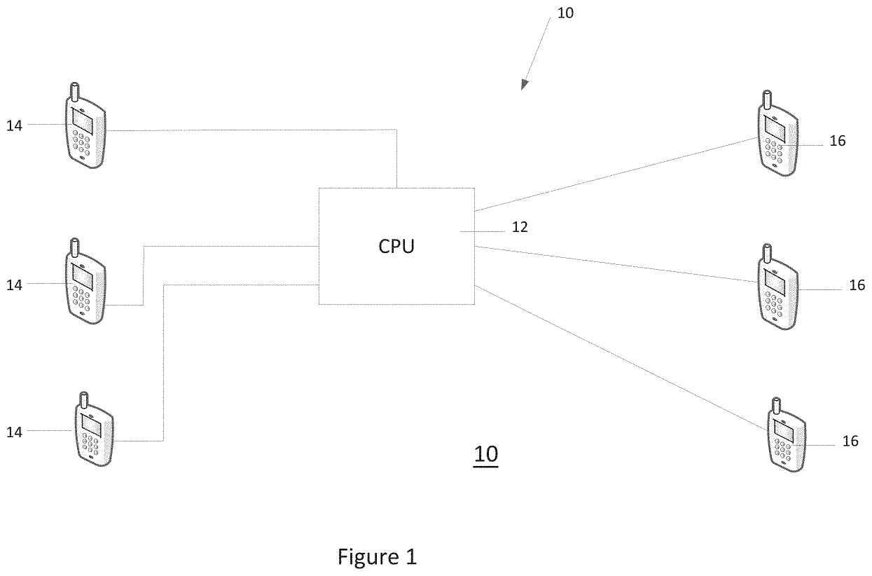

Turning to FIG. 1, a schematic diagram of a system 10 for scheduling rides in a ride-sharing platform is shown. The system 10 may include a central processing until (CPU) 12, or server, that receives input from a plurality of driver devices 14 and a plurality of rider devices 16 (seen as handheld devices 14 and 16 respectively) and transmits outputs to the same driver devices 14 and rider devices 16, or travelers. Although handheld devices are shown, it is understood that other devices, such as, but not limited to, laptops, desktop computer and telephones, are contemplated. Communication between the driver devices 14 and rider devices 16 with the server 12 may be via any communication protocol. The server 12 may also enable communication between the driver devices 14 and rider devices 16, as will be outlined below.

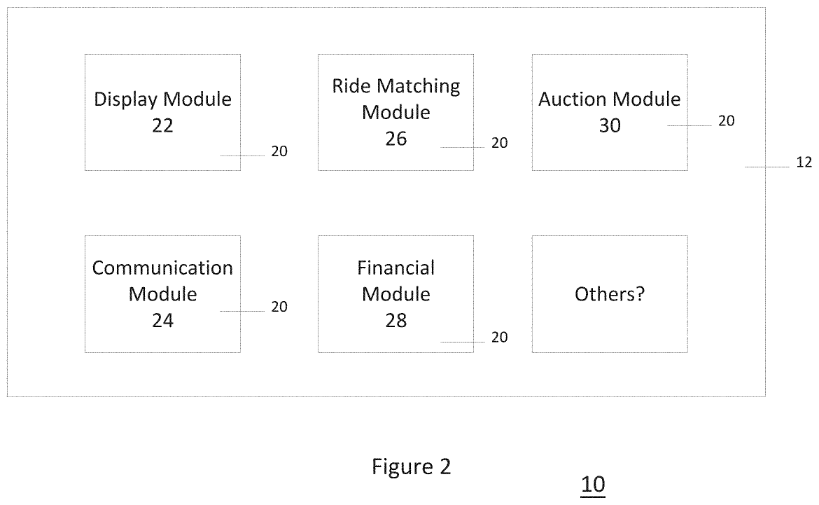

Turning to FIG. 2, a schematic diagram of the CPU, or server 12, is shown. The server 12 may include a plurality of modules 20 for enabling the system 10 of scheduling rides in a ride-sharing platform, in a clearing house for empty rides. In the current embodiment, the plurality of modules 20 may include a display module 22, a communication module 24, a ride-matching module 26, a financial module 28 and an auction module 30. The system 10 may further include an identification (ID) verification module for drivers and/or a data management module that manages information on travelers (riders) and drivers such as trip offers or trip requests.

In one embodiment, the display module 22 may generate images that are transmitted by the communication module 24 for display on the handheld driver devices 14 and rider devices 16 of the drivers and riders. These images may include display screens enabling the functionality for a driver to connect with a rider, or vice-versa, to set up, or plan, a trip. The communication module 24 may also handle disputes between drivers and riders.

The ride-matching module 24 receives input from rider devices 16 such as, but not limited to, rider trip information, rider price information, a driver and/or trip selection. The ride-matching module 26 may also provide notification of trip requests listed by riders and received as rider input on the plurality of rider devices 16 to the plurality of driver devices 14 or trips listed and input by drivers to riders. The rider trip information may include a rider destination location, a rider starting location, the number of passengers (or seats needed) and when the trip is scheduled for. Rider price information may include, but is not limited to, a price the rider is willing to pay for a trip, a bid price or a driver's price that the rider is willing to accept. As will be understood, the price that the rider is willing to pay may also be part of the trip information. The driver selection may be an input where the rider has selected a driver's offer for a trip to a predetermined destination (as discussed below).

The ride-matching module 24 also may receive input from drivers to the plurality of driver devices 14 such as, but not limited to, driver trip information, driver price information, rider selection. The driver trip information may include a driver destination location, a driver starting location and/or the number of passengers the driver may be able to accommodate. The driver price information may include an offer price that the driver is willing to drive passengers to the driver destination location or a price range that a driver may be willing to accept with respect to rider trip information.

As will be understood, the ride-matching module 24 may also enable negotiation between a rider device 16 and a driver device 14, such as when the rider destination location is between the driver starting location and the driver destination location. The negotiation may include price information. The system 10 may provide search functionality to allow for handling trips where a rider's destination is between the drivers starting location and final destination.

In one embodiment of the system 10, drivers may post empty runs by entering driver input to respective of the driver devices 14, which may be uploaded to a list provided by server 12 where the listed empty runs may be viewed and booked by travelers (or riders). System 10 may indicate empty runs in a manner that is viewable on rider devices 16 as return trips where the driver has no passengers. For instance, the driver may transport passengers to an airport (from an originating location 2 hours away) and may not have any passengers booked for the return trip back to their original starting point. This may be depicted by system 16 as an empty run that is viewable on the plurality of rider devices 16. It would be beneficial to the driver to drive back to the original starting point with any number of passengers, even at a discounted rate. In another embodiment, riders can post rider input via the plurality of rider devices 16 information for planned trips, which may be uploaded to a list provided by server 12, where the planned trips information may be viewed on the plurality of driver devices 14 and booked or accepted by drivers via the driver devices 14. Either group (the riders via the rider devices 16 or the drivers via the driver devices 14) may select from the others' list and “lock down” a trip by indicating agreement via the driver devices 14 to a posted price, or the drivers may opt to enable bidding on their item by riders via the rider devices 16 until time runs out, in the hope of acquiring a more advantageous outcome. Alternatively, the system 10 may also provide each group with a list of suggested options.

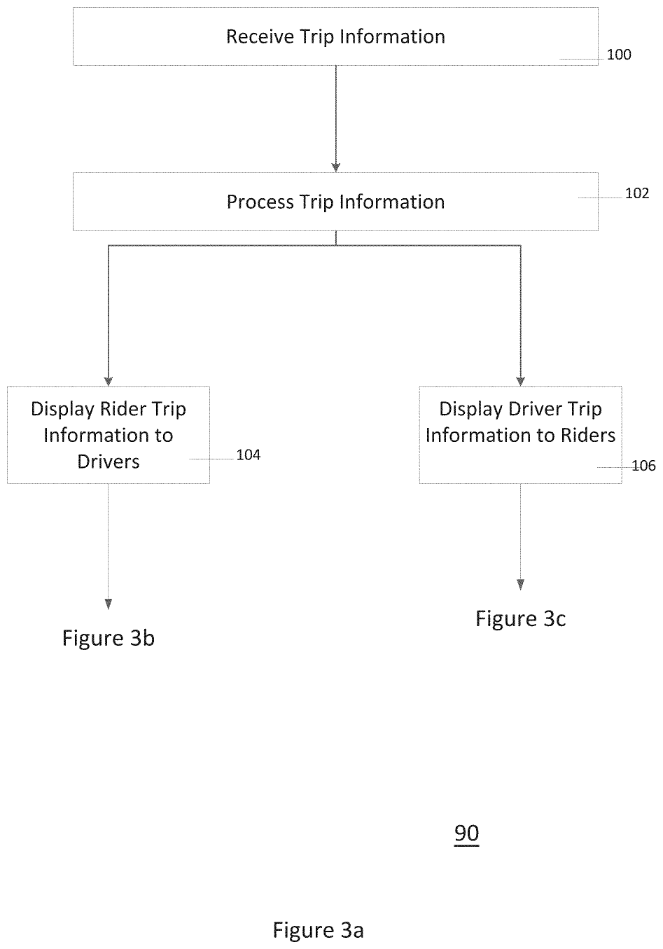

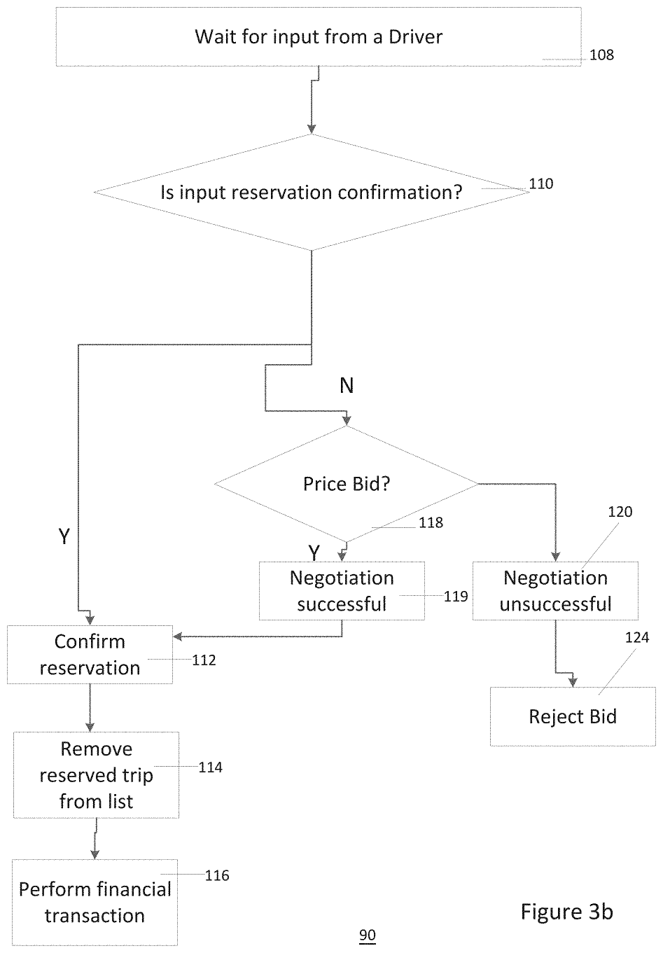

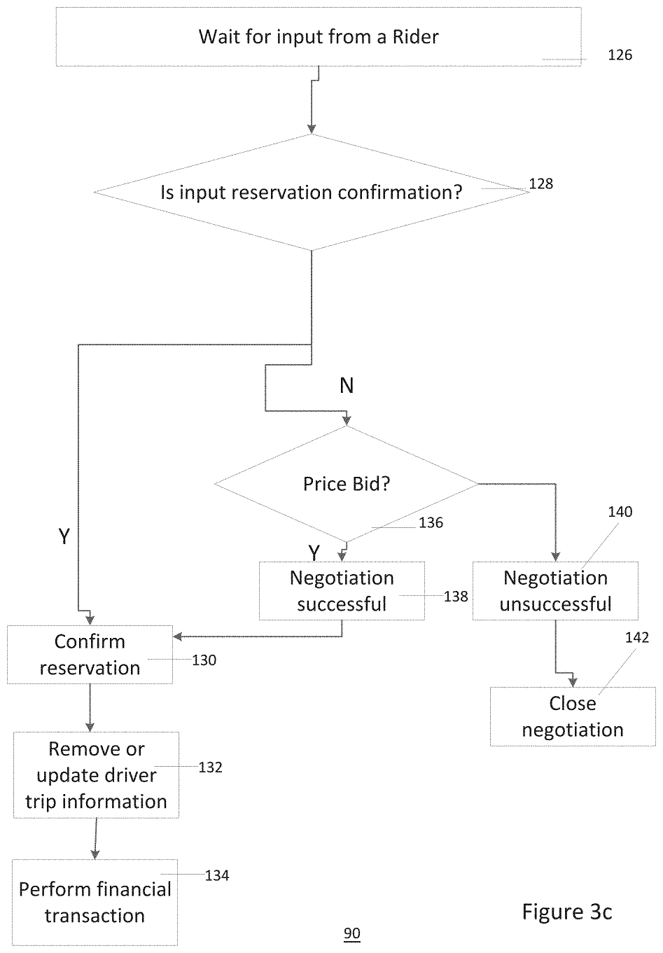

Turning to FIG. 3a, a flowchart outlining a method 90 of scheduling rides in a ride-sharing platform is shown. Method 90 may include receiving 100 initial trip information, such as in the form of rider trip information or driver trip information, by the system. The system may be structured and may function in a manner identical or similar to system 10, described elsewhere in this disclosure. Method 90 may include processing 102 trip information. Such trip information may include rider trip information and driver trip information. As outlined above, the rider trip information may include information associated with transportation assistance that the rider is hoping to obtain or reserve. The rider rip information may include originating location information, destination information, passenger information and pricing information such as the price the rider is willing to pay. In one embodiment, a rider may post a planned trip where they wish to travel from location A to location B at a certain time and on a certain date. The rider may also post a “book now” price of whatever amount they wish so that a driver can secure the trip at any time if the driver agrees to provide the transportation for the trip at the “book now” price. The rider may also decide to make the price negotiable. The driver trip information may include destination information, route information, passenger information and/or pricing information. In one example, a driver may post trip information associated with an empty run from location A to location B at a certain time and on a certain date. The driver can also post a “book now” price of whatever amount they wish for the trip so a rider can secure the trip at any time if the rider, or traveler, agrees to pay the “book now” price. Alternatively, the driver may set a price that is negotiable.

Method 90 may include, after receiving the trip information, processing 102 the trip information. Method 90 also may include displaying 104 the rider trip information to the drivers via the plurality of driver devices 114. Method 90 also may include displaying 106 the driver trip information to the riders via the plurality of rider devices 116. Processing 102 of the trip information may include placing the input (or inputs) from either the rider via the rider devices 116 or the driver via the driver devices 114 into a table for storing in a database. Further processing of the information may also be performed so that it is in a format to be displayed. As a result, drivers may be provided via the driver devices with a list of travelers, or riders, who may not want to pay retail for private transfers and who are willing to be inconvenienced to some degree in order to obtain a discount. Also, travelers, or riders, may be provided via the rider devices with a list of drivers who are willing to accept less than retail price for private transfers in order to not travel back to their originating destination empty or travel to a schedule pick-up empty.

With respect to the rider trip information displayed to the drivers, as schematically shown in (FIG. 3b), the system then waits until input is received from a driver (108). Method 90 may include waiting 108 for driver input from a driver, via a driver device 114. Method 90 may include determining 110 reservation confirmation, wherein the system 10 may determine if the input received is a reservation confirmation. Method 90 may include determining 110 whether a reservation is confirmed. If in determining 110 the input is determined by system 10 to be a reservation confirmation, the system 10 may perform confirming 112 of the reservation and may communicate such confirmation to both the rider device 116 and the driver device 114. Method 90 may include, when in confirming 112 a reservation is determined to be confirmed, removing 114 by the system 10 the trip from the list provided by server 12 to the driver devices 114 for drivers to see. In one embodiment, method 90 also may include performing 116, by the system, the financial part of the transaction whereby payment from the rider's payment account or the like is transmitted in whole or in part to the driver deposit account or the like.

Method 90 may include, in determining 110, making determination that the input is not a reservation confirmation. Method 90 may include price bidding 118 where determining 110 indicates that input is not a confirmation of reservation. Price bidding 118 may include assuming that the input received from a rider device 116 is a rider's price bid. Price bidding 118 may include, if the rider has made the price negotiable, sending back from a driver device 114 a driver's price bid (the price bid) indicating a price that the driver is willing to accept to complete the trip posted by the rider via the rider device 116. Alternatively, the bid may be an auction bid. Method 90 may include successful negotiating 119 that price negotiation is successful. If the rider via rider device 116 accepts the driver price bid, or the driver wins an auction for the trip such that negotiation determining 119 is successful, the system 10 may perform the confirming 112 and provide communication confirming the reservation to both the rider via the rider device 116 and to the driver via the driver device 114. Method 90 also may include the removing 114 of the trip from the list that the drivers via driver devices 114 are able to see. It will be understood that the driver via driver device 114 may submit multiple price bids or auction bids until successful negotiating 119 is completed or successful. In one embodiment, method 90 may also include the system performing 116 the financial part of the transaction whereby payment from the rider's payment account or the like is transmitted in whole or in part to the driver deposit account or the like.

If the rider via the rider device 116 does not accept the price (whereby the negotiation is unsuccessful) (120), the system rejects the bid and takes no confirmation action (124) indicating that the bid is rejected. It will be understood that further negotiation may occur, either form the same driver or a different driver. Bids may also be retracted if a driver's schedule changes or the drive confirms with a different traveler.

With respect to the driver tip information displayed to the riders, as schematically shown in (FIG. 3c), method 90 may include the system then waiting 126 until input is received from a rider (126). Method 90 also may include, by the system, determining confirmation 128 if the rider input received from a rider device is a reservation confirmation from a rider via a rider device. If in determining confirmation 128 the input is determined to be a rider reservation confirmation from a rider device, method 90 may include the system confirming 130 the reservation to both the rider via the rider device and to the driver via the driver device. Method 90 may include removing 132 or updating the trip information in the list that the riders are able to see on the plurality of rider devices. For instance, if the driver is able to accommodate ten passengers and the rider requires ten seats, the driver trip information is removed, but if the rider only requires four seats, in removing 132 the driver trip information may be updated to reflect that they have six seats remaining in their trip. In one embodiment, method 90 may include performing 134, by the system, the financial part of the transaction, whereby payment from the rider's payment account or the like is transmitted to the driver deposit account or the like.

Method 90 may include price bidding 136. If in determining confirmation 128 the rider input is determined not to be a reservation confirmation, then in price bidding 136 it may be assumed that the input received from a rider device is a rider's price bid. If the driver has made the price negotiable, a rider via the rider device may send back a rider's price bid (the price bid) that the rider is willing to pay for the driver's posted trip. Alternatively, the price bid may be an auction bid. If the driver accepts the rider's price bid or the rider wins an auction for the trip such that successful negotiation 138 is determined, the system may communicate confirmation 130 of successful negotiation of the reservation to both the rider via rider device and the driver via driver device. Method 90 may include removing 132 or updating the trip information from the list that the riders are able to see (132) such as outlined above. It will be understood that the driver may submit multiple price bids or auction bids until negotiation is completed or successful. Method 90 also may include the system performing 134 the financial part of the transaction (134) whereby payment from the rider's payment account or the like is transmitted to the driver deposit account or the like if the negotiations are unsuccessful (140), the system closes the negotiation (142).

It will be understood that although the steps depicted in flowchart(s) shown in FIGS. 3a-3c may occur in a linear manner, the driver via driver device or the rider via rider device may participate in multiple ongoing negotiations. In an alternative embodiment, the rider or driver may list no price on the trip, and system 10 may solicit or invite drivers or riders to bid on the trip, with the auction being completed at a predetermined time. In another embodiment, the driver via the driver device may indicate acceptance of multiple trips from riders in order to fill their vehicle.

With respect to bidding, both riders and drivers may choose to accept bids on their posted trip information. The longer that the driver's empty run is up for bidding, the odds may improve for a driver to get a higher price for the run as competing travelers' bids on it may drive the price up. However, the driver this may also result in the driver having no passengers on their return trip if they are following a strict time schedule. Also, the longer that a traveler's trip is up for bidding, the greater the odds of the traveler having to pay less as competing drivers' bids may drive the traveler's “tag along” price down. However, the odds of either driver or traveler being disappointed may also increase as the bidding deadline approaches.

In one embodiment, once a trip has been booked or scheduled, the financial module may not take the full price of the trip, it may only take a portion of the financial commitment from the rider's payment account. The system 10 may also transmit notices to the rider and the driver with the other's respective contact information such that they are able to directly communicate with each other work out the details of their pickup, drop off, payment of the remainder of the fee etc.

In another embodiment, the system may automatically review the driver trip information list and the rider trip information list and make recommendations based upon user defined parameters. For instance, a driver may say that they are willing to wait no more than four hours after a paid run in order to not drive home empty, or they might be willing to leave up to three hours earlier than planned in order to have paying passengers on a run to pick up at an airport. The same functionality may be provided to riders.

One advantage of the disclosure is that the profits of van, limousine, and other licensed livery operators may be increased since the system may enable drivers to acquire passengers who otherwise would not be able to afford their services for the empty portions of their vehicle's trips, i.e. to or from an airport for a pick up or drop off, or to the beach from the jungle or vice versa. These may also be seen as “point to point private transfers.” Another advantage of the disclosure is that the system may travelers who can't afford the normal prices for private livery service to access private transfers at a discounted rate in exchange for minor delays or other, nominal inconveniences.

Other advantages that a rider may experience include, but are not limited to, additional safety, due to an exclusive use of government-licensed livery; door to door, planned service instead of curb-side pickups, and sometimes multiple transfer/exchange points, such as when using shared ride services which require clients to sue other transportation to get to pickup and drop-off points; allows for pre-planning; enhanced security of their person because of booking/using discount private transportation system vs. negotiating with a cab or other private operator in high pressure and perhaps dangerous situations such as curbside at airport, etc.; and protection against price gouging; i.e. being told one price then having another be demanded at the destination.

Other advantages that the driver may experience include, but are not limited to, an increase in gross revenue per trip increases substantially due to running empty less often, operating costs per mile/kilometer drop substantially, net profits increase profoundly with minimal increase in vehicle wear and tear; an easier time acquiring additional travelers to reduce “empty running time” compared to curbside negotiations and/or hours spent phoning around to hotels and other sources of clientele; security of person as traveler ID may be provided through payment processing; security of payment as payment is made by traveler prior to pick-up and provided to livery after drop off.

Although the present disclosure has been illustrated and described herein with reference to preferred embodiments and specific examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

What is claimed is:

1. A method of scheduling rides in a ride-sharing platform, said platform comprising a platform server having a processor, said platform server comprising platform module software providing a plurality of modules configured to perform module functions, said platform comprising application software installed on a plurality of driver wireless devices in communication with said platform server via a data communication network, said platform comprising the application software installed on a plurality of rider wireless devices in communication with said platform server via the data communication network, said method comprising:
sending, from the plurality of driver devices, data communications to a communication module on the server, said data communications including driver trip information for the plurality of driver devices;
sending, from the plurality of rider devices, data communications to the communication module on the server, said data communications including rider trip information for the plurality of rider devices;
receiving, by a ride matching module on the server, the driver trip information, said driver trip information comprising driver destination information and driver starting location;
receiving, by the ride matching module on the server, the rider trip information, said rider trip information comprising rider destination information and rider starting location;
sending, by the communication module, to at least one matched driver device the rider trip information comprising the rider destination information and rider starting information for at least one matched rider device, the at least one matched driver device determined by the ride matching module comparing at least the rider destination information for the at least one matched rider device with the driver destination information for the at least one matched driver device;
displaying, on the at least one matched driver device, the at least one rider destination information and rider starting information for the at least one matched rider device;
waiting, by the ride matching module, for reservation input to be received by the at least one matched driver device; and
confirming, by the ride matching module, reservation input received by the at least one matched rider device.

2. The method of claim 1, said method comprising:
negotiating, by an auction module on the server, an agreed price for ride-sharing service to the rider destination for the matched driver device and the matched rider device.

3. The method of claim 2, said method comprising:
said confirming responsive to said negotiating an agreed price.

4. The method of claim 2, said method comprising:
said negotiating an agreed price comprising first receiving a driver acceptable price for the ride-sharing service to the rider destination.

5. The method of claim 2, said method comprising:
said negotiating an agreed price comprising first receiving a rider acceptable price for the ride-sharing service to the rider destination.

6. A platform server configured to perform the method of claim 1.

7. A platform server configured to perform the method of claim 2.

8. A platform server configured to perform the method of claim 3.

9. A platform server configured to perform the method of claim 4.

10. A platform server configured to perform the method of claim 5.

11. A non-transitory computer-readable medium having tangibly embodied thereon and accessible therefrom processor-executable instructions that, when executed by at least one data processing device of a data processing system, causes said at least one data processing device to perform the method of claim 1.

12. A non-transitory computer-readable medium having tangibly embodied thereon and accessible therefrom processor-executable instructions that, when executed by at least one data processing device of a data processing system, causes said at least one data processing device to perform the method of claim 2.

13. A non-transitory computer-readable medium having tangibly embodied thereon and accessible therefrom processor-executable instructions that, when executed by at least one data processing device of a data processing system, causes said at least one data processing device to perform the method of claim 3.

14. A non-transitory computer-readable medium having tangibly embodied thereon and accessible therefrom processor-executable instructions that, when executed by at least one data processing device of a data processing system, causes said at least one data processing device to perform the method of claim 4.

15. A non-transitory computer-readable medium having tangibly embodied thereon and accessible therefrom processor-executable instructions that, when executed by at least one data processing device of a data processing system, causes said at least one data processing device to perform the method of claim 5.

16. A wireless communication device, said device comprising:
said device configured to operate in a ride-sharing platform to perform steps of a method of scheduling rides in the ride-sharing platform, wherein said platform comprises a platform server having a processor, said platform server comprising platform module software providing a plurality of modules configured to perform module functions, said platform comprising application software installed on a plurality of driver wireless devices in communication with said platform server via a data communication network, said platform comprising the application software installed on a plurality of rider wireless devices in communication with said platform server via the data communication network, said method comprising:
sending, from the plurality of driver devices, data communications to a communication module on the server, said data communications including driver trip information for the plurality of driver devices;
sending, from the plurality of rider devices, data communications to the communication module on the server, said data communications including rider trip information for the plurality of rider devices;
receiving, by a ride matching module on the server, the driver trip information, said driver trip information comprising driver destination information and driver starting location;
receiving, by the ride matching module on the server, the rider trip information, said rider trip information comprising rider destination information and rider starting location;
sending, by the communication module, to at least one matched driver device the rider trip information comprising the rider destination information and rider starting information for at least one matched rider device, the at least one matched driver device determined by the ride matching module comparing at least the rider destination information for the at least one matched rider device with the driver destination information for the at least one matched driver device;
displaying, on the at least one matched driver device, the at least one rider destination information and rider starting information for the at least one matched rider device;
waiting, by the ride matching module, for reservation input to be received by the at least one matched driver device; and
confirming, by the ride matching module, reservation input received by the at least one matched rider device;
said wireless communication device configured to function as one of the following:
the driver device,
the rider device.

17. A system providing a ride-sharing platform, said system comprising:
said system configured to perform steps of a method of scheduling rides in the ride-sharing platform;
said system comprising a platform server having a processor, said platform server comprising platform module software providing a plurality of modules configured to perform module functions,
said system comprising a plurality of driver wireless devices in communication with said platform server via a data communication network;
said system comprising a plurality of rider wireless devices in communication with said platform server via the data communication network;
said system comprising application software installed on the plurality of driver wireless devices for communication with said platform server via the data communication network;
said system comprising the application software installed on a plurality of rider wireless devices in communication with said platform server via the data communication network;
said steps comprising:
sending, from the plurality of driver devices, data communications to a communication module on the server, said data communications including driver trip information for the plurality of driver devices;
sending, from the plurality of rider devices, data communications to the communication module on the server, said data communications including rider trip information for the plurality of rider devices;
receiving, by a ride matching module on the server, the driver trip information, said driver trip information comprising driver destination information and driver starting location;
receiving, by the ride matching module on the server, the rider trip information, said rider trip information comprising rider destination information and rider starting location;
sending, by the communication module, to at least one matched driver device the rider trip information comprising the rider destination information and rider starting information for at least one matched rider device, the at least one matched driver device determined by the ride matching module comparing at least the rider destination information for the at least one matched rider device with the driver destination information for the at least one matched driver device;
displaying, on the at least one matched driver device, the at least one rider destination information and rider starting information for the at least one matched rider device;
waiting, by the ride matching module, for reservation input to be received by the at least one matched driver device; and
confirming, by the ride matching module, reservation input received by the at least one matched rider device.
